(19) United States
(12) Patent Application Publication
(10) Pub. No.: US 2008/0250008 A1
(43) Pub. Date: Oct. 9, 2008

(54) Query Specialization

(75) Inventors: Sreenivas Gollapudi, Cupertino, CA (US); Rakesh Agrawal, San Jose, CA (US); Evimaria Terzi, Helsinki (FI)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/696,455

(22) Filed: Apr. 4, 2007

(51) Int. Cl. G06F 17/30

(52) U.S. Cl. 707/5

(57) ABSTRACT

A system, a method and computer-readable media for identifying and presenting potential query refinements for a user's search input. Documents are identified as being responsive to the search input. A query log is accessed to identify previously entered queries that also returned one or more of the identified documents. From these previously entered queries, a portion of the queries are selected as potential query refinements. Thereafter, the potential query refinements are displayed to the user.

### BACKGROUND

The Internet has vast amounts of information distributed over a multitude of computers, hence providing users with large amounts of information on various topics. Other communication networks, such as intranets and extranets, may also provide a sizeable quantity of diverse information. Although large amounts of information may be available on a network, finding desired information may not be easy or fast.

Search engines have been developed to address the problem of finding desired information on a network. A conventional search engine includes a crawler (also called a spider or bot) that visits an electronic document on a network, “reads” it, and then follows links to other electronic documents within a Web site. The crawler returns to the Web site on a regular basis to look for changes. An index, which is another part of the search engine, stores information regarding the electronic documents that the crawler finds. In response to one or more user-specified search terms, the search engine returns a list of network locations (e.g., uniform resource locators (URLs)) and metadata that the search engine has determined include electronic documents relating to the user-specified search terms. Some search engines provide categories of information (e.g., news, web, images, etc.) and categories within these categories for selection by the user, who can thus focus on an area of interest.

Search engine software generally ranks the electronic documents that fulfill a submitted search request in accordance with their calculated relevance and provides a means for displaying search results to the user according to their rank. A typical relevance ranking is a relative estimate of the likelihood that an electronic document at a given network location is related to the user-specified search terms in comparison to other electronic documents. For example, a conventional search engine may provide a relevance ranking based on the number of times a particular search term appears in an electronic document, or based on its placement in the electronic document (e.g., a term appearing in the title is often deemed more important than the term appearing at the end of the electronic document), etc. Link analysis, anchor-text analysis, web page structure analysis, the use of a key term listing, and the URL text are other known techniques for ranking web pages and other hyperlinked documents.

Getting the most relevant results depends on the query issued by the user. Often the user might not have all the information to formulate the right query that returns the most relevant results to the user. This results in the user refining the query many times (sometimes with little success) to get the results she is looking for.

Currently available search engines, however, are generally limited in their ability to aid users in the refinement of search queries. For example, a user may be looking for some specific item of information but may not know the “ideal” query to generate the desired results. In the absence of query refinement tools, the user must try different queries before arriving at the specific item of information. In another example, a user may start with a generic query with the desire to browse related queries. Here again, the user's ability to explore the result space will be adversely impacted by the absence of adequate query refinement tools.

### SUMMARY

The present invention provides systems and methods for identifying and presenting potential query refinements for a user's search input. Documents are identified as being responsive to the search input. For example, a user may submit a search input to an Internet search engine, and the search engine may identify a set of relevant documents. A query log is accessed to identify previously entered queries that also returned one or more of the identified documents. From these previously entered queries, a portion of the queries are selected as potential query refinements. Thereafter, the potential query refinements are displayed to the user.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of an exemplary network environment suitable for use in implementing embodiments of the present invention;

FIG. 2 illustrates a method in accordance with one embodiment of the present invention for identifying search queries relevant to a search input;

FIGS. 3A and 3B are graphical representations of a result set area in accordance with one embodiment of the present invention;

FIG. 4 is a block diagram illustrating a system for presenting potential refinements to a user's search query in accordance with one embodiment of the present invention; and

FIG. 5 illustrates a method in accordance with one embodiment of the present invention for refining a user's search query by suggesting potential query refinements.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

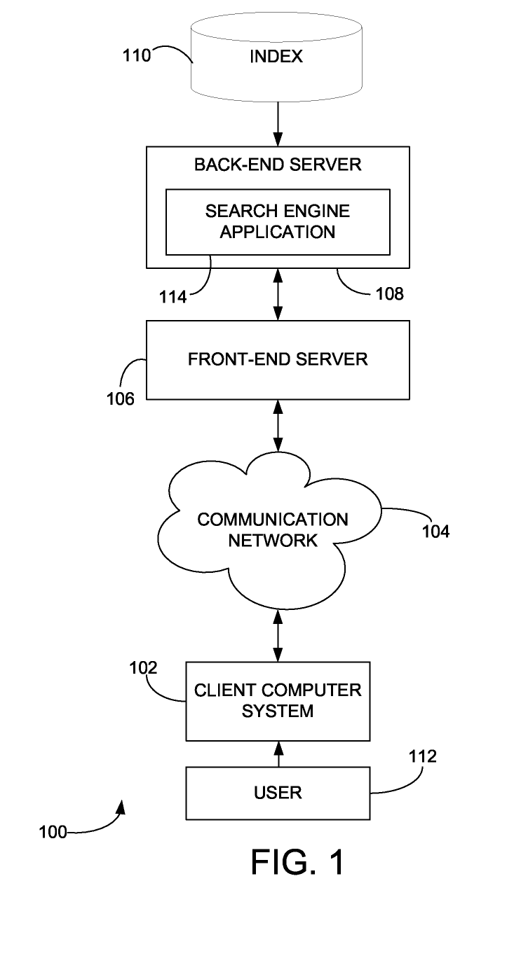

Referring initially to FIG. 1 in particular, an exemplary network environment for implementing the present invention is shown and designated generally as network environment 100. Network environment 100 is but one example of a suitable environment and is not intended to suggest any limitation as to the scope of use or functionality of the invention. Neither should the network environment 100 be interpreted as having any dependency or requirement relating to any one or combination of elements illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices, servers, etc. The invention may also be practiced in distributed computing environments where tasks are performed by remote-processing devices that are linked through a communications network.

Referring now to FIG. 1, a client 102 is coupled to a data communication network 104, such as the Internet (or the World Wide Web). One or more servers communicate with the client 102 via the network 104 using a protocol such as Hypertext Transfer Protocol (HTTP), a protocol commonly used on the Internet to exchange information. In the illustrated embodiment, a front-end server 106 and a back-end server 108 (e.g., web server or network server) are coupled to the network 104. The client 102 employs the network 104, the front-end server 106 and the back-end server 108 to access Web page data stored, for example, in a central data index (index) 110.

Embodiments of the invention provide searching for relevant data by permitting search results to be displayed to a user 112 in response to a user-specified search request (e.g., a search query). In one embodiment, the user 112 uses the client 102 to input a search request including one or more terms concerning a particular topic of interest for which the user 112 would like to identify relevant electronic documents (e.g., Web pages). For example, the front-end server 106 may be responsive to the client 102 for authenticating the user 112 and redirecting the request from the user 112 to the back-end server 108.

The back-end server 108 may process a submitted query using the index 110. In this manner, the back-end server 108 may retrieve data for electronic documents (i.e., search results) that may be relevant to the user. The index 110 contains information regarding electronic documents such as Web pages available via the Internet. Further, the index 110 may include a variety of other data associated with the electronic documents such as location (e.g., links, or URLs), metatags, text, and document category. In the example of FIG. 1, the network is described in the context of dispersing search results and displaying the dispersed search results to the user 112 via the client 102. Notably, although the front-end server 106 and the back-end server 108 are described as different components, it is to be understood that a single server could perform the functions of both.

A search engine application (application) 114 is executed by the back-end server 108 to identify web pages and the like (i.e., electronic documents) in response to the search request received from the client 102. More specifically, the application 114 identifies relevant documents from the index 110 that correspond to the one or more terms included in the search request and selects the most relevant web pages to be displayed to the user 112 via the client 102.

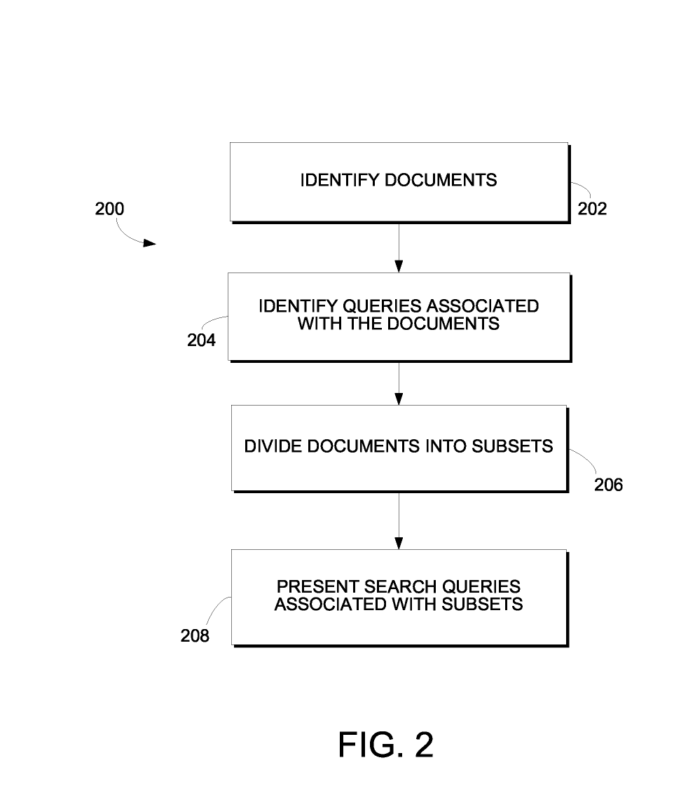

FIG. 2 illustrates a method 200 for identifying search queries relevant to a search input. At 202, a set of documents are identified as being responsive to a search input received from a user. In one embodiment, a user may access a search engine such as the Internet search engine illustrated by FIG. 1. In particular, a search engine application may identify a set of documents (i.e., web pages) in response to a search input. In this embodiment, the search engine identifies relevant documents that correspond to terms included in the search input and selects the most relevant documents. Those skilled in the art will appreciate that a variety of techniques exist to identify documents that are relevant to a search input.

At 204, search queries associated with the selected documents are identified. A variety of techniques may exist to associate documents with search queries. For example, a query log may be accessed at the step 204. In this example, the query log may store previously entered queries submitted to the search engine. The query log may track not only the previous queries but also the documents identified as being most relevant to those queries. So, for a given document, it may be determined which previously entered queries also returned that document. In an alternative embodiment, queries may be associated with a document by tagging the document with a query or by storing the query associations in some alternative data store that is distinct from a query log. By utilizing a query log or other data source, search queries associated with the selected documents may be identified.

The set of identified documents is divided into subsets at 206. For example, one of the various search queries identified at the step 204 may be selected, and each of the documents associated with this query may be grouped together in a subset. This process may be repeated for different search queries so as to divide the set of identified documents into numerous subsets. Accordingly, each of the subsets is generated by grouping documents having a common search query association. For example, a query log with the top 250 results for each previously-entered query may be used. Given a user query, the result space of the query (i.e., the top 250 documents) may be partitioned into k-regions, and the representative query for each region may be returned. In one embodiment, the subsets may “cover” the original user query as much as possible. Depending on the query-selection algorithm employed, the k-regions may be approximately of the same size and may be pairwise disjoint, i.e., the overlap between any two regions is small. By ensuring the size of each region is approximately equal to all other regions, it is ensured that no query which is similar to the user query is suggested as a refinement. Note that suggesting a similar query to the user does not offer any new information to the user in terms of refining the query.

At 208, the search queries associated with the various subsets are presented to the user. These search queries may be thought of as query refinements as they suggest a variety of different queries directed to sub-domains of the original result space. These query refinements help expand the search space and ideally facilitate the exploration of related results.

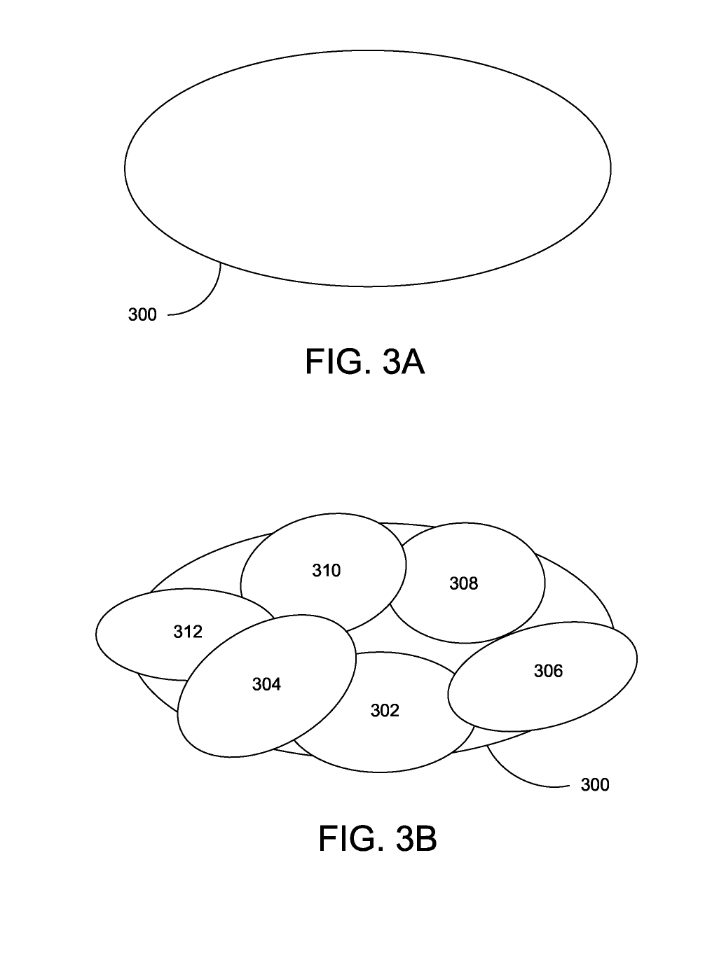

FIG. 3A provides a graphical representation of a result set area 300, while FIG. 3B illustrates the result set area 300, as divided into subset areas 302, 304, 306, 308, 310 and 312. For example, a query s may represent a suggestion for query q if its result set has a large overlap with q, i.e., |R(q) ∩ R(s)| is large. Here R(.) denotes the result set of the specified query. So, the result set area 300 graphically illustrates R(q), while the subset areas 302, 304, 306, 308, 310 and 312 correspond to R(sᵢ) for i=1, . . . , 5.

In one embodiment, the size of a range may be defined as |R(q)|/2k≦|R(q) ∩ R(s)|≦2R(q)|/k, where k is the number of suggestions requested by the user. As will be appreciated by those in the art, imposing limits on the size for each suggestion admits a solution that uniformly samples the result set of the original query. So, given query q, one embodiment seeks to find a set of suggestions S such that |R(S) ∩ R(q)| is maximized while, at the same time, the amount of “extra” information pulled in |R(S)−R(q)|≦small constant. As will be appreciated by those skilled in the art, FIG. 3B provides an illustration of suggestions generated in accordance with this embodiment; the subset areas 302, 304, 306, 308, 310 and 312 are within the same size range; substantially all of the area 300 is covered by the subsets; and the subset areas 302, 304, 306, 308, 310 and 312 generally do not extent beyond the bounds of the area 300. While FIG. 3B provides a graphical illustration of one approach to dividing a result set into query suggestions, numerous such approaches may be used in connection with embodiments of the present invention. Indeed, the “query suggesting problem” may be formulated in a variety of ways, and different algorithms may be employed to generate search query suggestions.

To formally discuss the query suggesting problem and its variants, a variety of notations may be introduced. To this end, let W denote the set of all web pages. For a given query q, denote by q(W) the set of all pages (set of URLs) in W that are in the result set of q. Use q(W, k) to refer to the top-k elements of q(W) and call the elements in q(W) (or q(W, k)) the positive coverage of query q, which is denoted by C⁺(q). Similarly, refer to the set of elements in W\q(W) as the negative coverage of query q, which is denoted by C⁺(q). The above notation can be extended from queries to sets of queries. That is, for a set of queries Q, define the positive coverage of Q to be C⁺(Q)=∪ q εQ C⁺(q) and similarly C⁻(Q)=∪ q εQ C⁻(q). It may be observe that by keeping the “extra” information as small as possible, an algorithm may produce specializations of the original query. By relaxing this constraint, the same algorithm produces related queries.

Using the above notation to formally define the query suggestion problem, one potential definition of query specialization is:

Definition 1. Given two queries q and q′ we say that q′ is a strict refinement of q if C⁺(q′) ⊂ C⁺(q).

Apparently, if query q′ is a specialization of query q, then q is a generalization of q′. Now assume query q′, such that C⁺(q)=C⁺(q). In this case, q′ is a specialization of q according to Definition 1. However, the fact that the result sets of the two queries are the same does not satisfy one's intuition of specialization. Intuitively, a specialization q′ of query q may be such that Condition 1 and Condition 2 are satisfied:

C⁺(q′) ⊂ C⁺(q). Condition 1

Condition 2:

$$\frac{\vert {C}^{+} ( q ) \vert}{α} \leq \vert {C}^{+} ( {q}^{′} ) \vert \leq \frac{\vert {C}^{+} ( q ) \vert}{β} ,$$

where α and β are constants.

Given Conditions (1) and (2), the following definition of a candidate specialization is given.

Definition 2. For input values a and,8 and queries q and q′, then q′ is a candidate specialization of q if Conditions (1) and (2) are satisfied.

Therefore, a query q′ is a candidate specialization for q if the result set of q′ is included in the result set of q, and at the same time the overlap between C⁺(q′) and C⁺(q) is significant enough, but not complete. Given the above conditions, the strict query specialization problem may be defined as follows.

Problem 1. Given integer k, a set of queries in the query log Q, and an input query q, find a set of k candidate specializations of q, Qₖ⊂Q, such that |C⁺(Qₖ) ∩ C⁺(q)| is maximized.

As will be observed by those skilled in the art, Problem 1 may be too strict, and one could expect that there can be query logs that do not contain a single query q′ that is a candidate specialization for a given query q. Therefore, the definition of the candidate specialization may be relaxed as follows.

Definition 3. A query q′ is an approximate specialization of query q if:

$$\frac{\vert {C}^{+} ( q ) \vert}{α} \leq \vert {C}^{+} ( {q}^{′} ) ⋂ {C}^{+} ( q ) \vert \leq \frac{\vert {C}^{+} ( q ) \vert}{β} ,$$

where α and β are given constants.

For example, assume the input query q=“Helsinki” defining the set C⁺(q), with |C⁺(q)|=1000. Additionally, consider the following five queries in the query log that have non-zero intersection with q: q1=“City of Helsinki”; q2=“University of Helsinki”, q3=“Helsinki this week”; q4=“Helsinki walking tour”; and q5=“Suomelina”. Query q1 is almost as generic as query q since most web pages that refer to Helsinki actually refer to the “City of Helsinki” as well. This means that although query q1 is closely related to query q, it might not be a good specialization of q, since essentially q and q1 have the same set of results and thus cover the same answer space. On the other hand, queries q2, . . . , q5 are indeed specializations of q since they refer to specific institutions, activities and places related to Helsinki. This example may provide some intuition regarding why parameters α and β in Definition 3 are often desirable; good specializations of query q are those that have relatively large intersection with C⁺(q), but at the same time they do not cover the whole C⁺(q). Indeed, queries that cover the whole C⁺(q) are related queries but not specializations of q.

Given Definition 3, one may define the query specialization problem as follows.

Problem 2. Given integer k, a set of queries in the query log Q, and an input query q, find a set of approximate specializations of q of cardinality k, Qₖ⊂Q, such that |C⁺(Qₖ) ∩ C⁺q1 is maximized.

Problem 2, therefore, seeks a set of k approximate specializations of a given query q that have the maximum possible intersection with C⁺(q).

Finally, a third alternative to the generic query suggestion problem is set forth below as Problem 3. For a given query q, one again may want to maximize the overlap between the output specializations and the result set of q. At the same time, they may want the output specializations to have a bounded overlap with the pages in C⁻(q). This problem may be referred to as the “Budgeted Query Specialization” problem, and it may be defined formally as follows:

Problem 3. Given integers k and l, a set of queries in the query log Q, and an input query q, find a set of k approximate specializations of q, Qₖ⊂Q, such that |C⁺(Qₖ) ∩ C⁺q1 is maximized, and

$${\sum }_{{q}^{′} ∈ {Q}_{k}} \vert {C}^{+} ( {q}^{′} ) \backslash {C}^{+} ( q ) \vert \leq l .$$

Since Problem 3 is seeking k specializations, it uses the input variable k to define the values of the parameters α and β. For example, one may set α=2k and β=k/2.

With the problem-space formally defined, a variety of exemplary algorithms are provided herein. The presented algorithms are greedy. As known to those in the art, a greedy algorithm repeatedly executes a procedure which tries to maximize the return based on examining local conditions, with the hope that the outcome will lead to a desired outcome for the global problem. The presented algorithms have provable approximation bounds for the proposed optimization problems. Moreover, these algorithms output query suggestions in a specific order, and therefore, they implicitly suggest a ranking of the output query suggestions.

The first exemplary algorithm may be referred to as the “GreedyCover” algorithm. This algorithm is a (1−1/e) approximation algorithm for Problem 2. For a given query q with positive coverage C⁺(q), the GreedyCover algorithm picks in each iteration query qᵢ with the highest remaining positive coverage. That is, in every iteration the algorithm picks the query whose answer sets span the largest number of yet uncovered elements in C⁺(q).

Although the GreedyCover algorithm is a constant-factor approximation algorithm for Problem 2, its approximation factor for Problem 3 can become unbounded. Specifically if the GreedyCover algorithm is used for solving the Problem 3 (i.e., the Budgeted Query Specialization problem), the algorithm will first pick query q′ that has the maximum overlap with the result set of query q′. However, since |C⁺(q′) ∩ C⁻(q)|=l the algorithm should stop, since the budget of t has been reached. Therefore, the GreedyCover algorithm would give a solution of coverage 2. However, the optimal solution would pick the queries q′₁ . . . q′ₘ and it would have a coverage of size m. Thus, in this example, the approximation factor of the GreedyCover algorithm is 2/m, which can be unbounded for large values of m.

Since the Budgeted Query Specialization problem puts a bound on the total number of pages not included in C⁺(q) that should be covered by the set of suggestions Qₖ, a modification of the GreedyCover algorithm that takes this requirement into account may be desirable. Such an algorithm may be referred to as the RatioCover algorithm. The RatioCover algorithm is again greedy. In each iteration, it picks query qᵢ with maximum |C⁺(qᵢ) ∩ R|/|C⁺(qᵢ) ∩ C⁺(q)|. That is, the selection criterion is such that it gives priority to queries that cover as many yet uncovered elements in C⁺(qᵢ) and as little elements in C⁻(qᵢ).

Although the RatioCover algorithm is a natural greedy algorithm for the Budgeted Query Specialization problem, it is not guarantee a bounded approximation factor for Problem 3. For example, if the greedy algorithm may pick query q₁ as a suggestion. This choice may disallow the algorithm to proceed picking also query q₂, since suggesting also q₂ may, in some scenarios, result in exceeding limit l. Therefore, the total coverage achieved by the greedy algorithm is 1, while the optimal algorithm would have picked query q₂ achieving optimal coverage p. Therefore, the performance ratio of the algorithm for this instance is 1/p. Since the value of p can be any natural number, the RatioCover algorithm may arbitrarily perform poorly.

A third exemplary algorithm, referred to as the GreedyCombine algorithm, combines aspects of the GreedyCover and RatioCover algorithms. The idea behind the GreedyCombine algorithm is to execute GreedyCover and RatioCover algorithms in parallel and take the solution that achieves the maximum coverage. By leveraging the advantages of the GreedyCover and RatioCover algorithms, the GreedyCombine algorithm may provide the most reliable approximation of the result space.

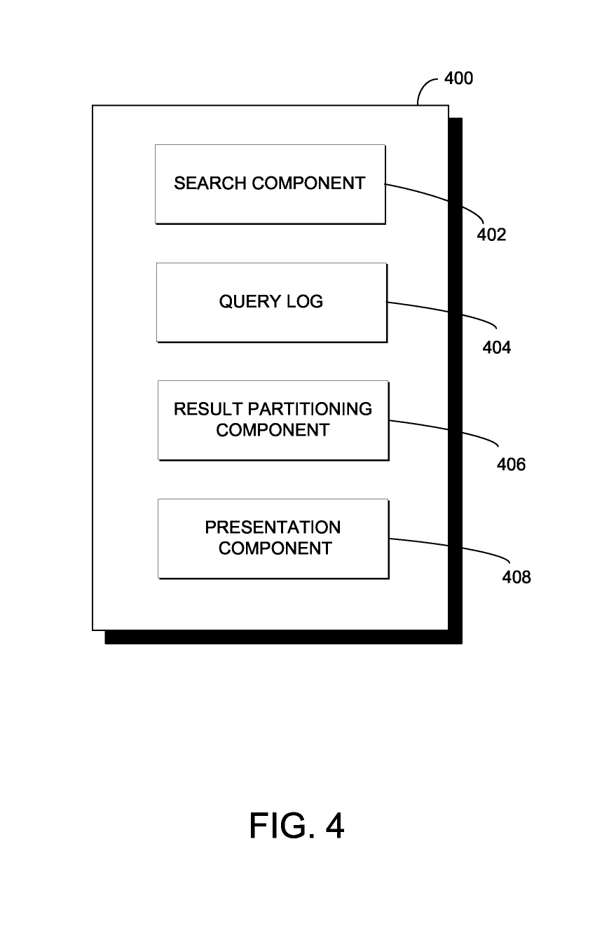

FIG. 4 illustrates a system 400 for presenting potential refinements to a user's search query in accordance with one embodiment of the present invention. The system 400 includes a search component 402. The search component 402 may be configured to select documents in response to a search query. In one embodiment, the search component 402 may interact with an index so as to identify a set of relevant documents responsive to the search input. Those skilled in the art will appreciate that a variety techniques exist for searching for documents that are relevant to a search input.

The system 400 also includes a query log 404. The query log 404 may be any compilation of data that stores associations between search queries and documents. For example, the query log 404 may record queries received by an Internet search engine, as well as identifiers for the returned web sites. The query log 404 may also track additional information such as the rankings of the returned results and the time a query request was made.

A result-partitioning component 406 is also included in the system 400. The result-partitioning component 406 is configured to use the associations stored in the query log 404 to divide the responsive documents into subsets. A subset includes documents associated with a common search query (as indicated by the query log 404), and this common query may be used to represent the subset. As previously explained, a variety of algorithms may be used in dividing the responsive documents into subsets, and the result-partitioning component 406 may implement any one of these algorithms. For instance, the partitioning algorithm may seek to divide the result space of the user query into 10 regions, and the representative query for each region may be returned by the result-partitioning component 406. After such partitioning, the subsets may cover the original user query as much as possible, while the overlap between any two regions is small and the size of each region is approximately equal to all other regions.

As an example, when queried for ‘HIV’, the following representative queries may be returned: (1) AIDS; (2) primary HIV infection; (3) lipodystrophy; (4) viral hepatitis; (5) Department of Health and Human Services; (6) drug resistance; (7) HCV; (8) antiretroviral therapy; and (9) approved drugs. As seen in this example, suggestions from different sub-domains of the result space are returned. Not all suggestions are similar to AIDS but are related in some form.

To present the representative queries, the system 400 includes a presentation component 408. In one embodiment, the presentation is presented via the Internet as a web page, though any number of presentation techniques may be acceptable. By presenting suggestions to the user that are related to the original search, the user may be enabled to more quickly locate a desired item of information and/or explore the result space.

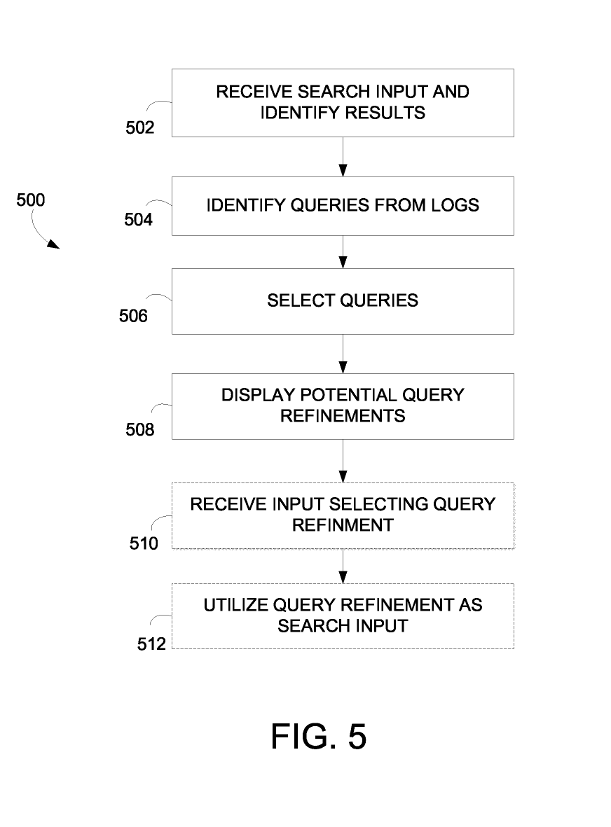

FIG. 5 illustrates a method 500 for refining a user's search query by suggesting potential query refinements. At 502, a search input is received from a user, and search results are identified. For example, a user may input the query to a client-based search utility or to an Internet search engine. In this example, the search engine's front-end server may receive this query. The search engine may then search an index of electronic documents and return the most relevant results. Those skilled in the art will appreciate that there are numerous techniques for generating a set of documents responsive to a search query.

At 504, a query log is utilized to identify search queries that were previously identified as being relevant to at least one of the documents in the result set. From these identified search queries, a portion are selected as potential query refinements at 506. As previously discussed, a variety of different algorithms may be employed in the selecting of search queries as potential query refinements. For example, one of the discussed greedy algorithms may be used to select the search queries.

Once the search queries are selected as potential query refinements, these refinements may be presented to the user at 508. Those skilled in the art will appreciate that any number of presentation techniques may be acceptable for displaying the potential query refinements. At 510, a user input is received selecting one of the refinements. In response to this input, at 512, the selected refinement is used as a search input and the steps 504, 506 and 508 are repeated. As such, the user is enabled to efficiently explore sub-topics associated with the selected refinement.

Those skilled in the art will appreciate that a variety of computational speedups may be employ in connection with embodiments of the present invention. Indeed, the complexity of the specialization algorithm may be linear to the number of queries in the query log, |Q|. More specifically, if k is the number of required specializations, then time O(kT|Q|) is needed. Parameter T corresponds to the time requirement for computing the greedy selection criterion for every query q′εQ. For an input query q, the algorithm needs to compute, in each iteration, the intersection between C⁺(q) and C⁺(q). Using the appropriate data structures this may require time min {C⁺(q),C⁺(q)}. In principle, the result set of a query can be equal to the search-engine index W. In one embodiment, a straightforward speedup can be achieved by restricting the size of the query results. For example, looking at the top 100 or 250 query results may be enough for exploring the answer set of a single query.

Further, the running time of the algorithm increases with the size of the query logs. For example, the running time can get large when the algorithm runs on query logs containing tens of millions of queries covering even larger number of documents. Sampling the space of URLs can give significant speedups on the running time of the algorithms. Therefore, instead of looking at all URLs in U=∪ q εQ R(q), one embodiment may uniformly sample the URLs from U.

To reduce the storage requirements for the query logs and decrease the computational requirements of the algorithms, one embodiment may use low-dimensional embeddings and project the query results space into a hamming cube. The queries can be represented as points in a high-dimensional document space where its dimensionality D is equal to the number of unique documents. Thus, a query q is represented by a vector v_{q} in the document space. Since the number of documents is very large on the web, this embodiment may embed these high-dimensional queries into a low-dimensional hamming cube (of dimension d<<D) in a similarity-preserving way, i.e., queries that are similar in the high-dimensional space will be closer in the hamming cube. Thus, all queries are points in {0, 1}^{d} where d is the dimension of the hamming cube and distances are measured by the hamming distance. To map a query q into the hamming cube of dimension d, v_{q} may be projected along d random projections R_{I}, . . . , R_{d}. Each Rᵢ is a random vector in {0, 1}^{D} where each element in the vector gets a value 0 with high probability 1−β2 and a value 1 with low probability, β/2. Thus, each element in the low-dimension hamming cube is the inner product R_{i.q} (mod 2).

Those skilled in the art will also appreciate that embodiments of the present invention may be implemented in a manner that takes into account a ranking of the query results. Indeed, the result sets returned by the search engines are generally ranked, and the ranking information may be important. In one embodiment, a multiset (instead of a set) representation of the result sets of queries is considered. That is, there may be multiple occurrences of each URL in the result set. In this embodiment, the number of occurrences of each page depends on the position of the page in the ranked query results.

More formally, consider a query q and its result set C⁺(q). Herein, let R_{q} refer to the ranked result set of query q. By definition |C⁺(q)|=|R_{q}| and, for every page pε C⁺(q), it holds that also pε R_{q} and vice versa. Finally, R_{q}(p) denotes the number of pages that are below page p in the ranked result set R_{q}. In one example, only the top-m results of every query is considered. If page p₁ appears first in the ranked result set of query q, then R_{q}(p₁)=m. Similarly, for the page pₘ that is in the last position of the ranked result set, then R_{q}(pₘ)=1. One interpretation of this weighing scheme is that if for a query q a page p has R_{q}(p)=γ, it may be assumed that page p appears γ times (instead of one) in the result set of query q. As will be appreciated by those skilled in the art, the intuition behind this weighting scheme is that different pages are given different significance according to their position in the ranked results.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. One or more computer-readable media having computer-useable instructions embodied thereon to perform a method for refining a user search query, said method comprising:
identifying a plurality of documents that are relevant to a search input received from a user;
utilizing a query log to identify a plurality of search queries that were previously identified as being relevant to at least one of said plurality of documents;
selecting one or more of said plurality of search queries as potential query refinements; and
displaying said potential query refinements to the user.

2. The media of claim 1, wherein at least a portion of said plurality of documents are web pages.

3. The media of claim 2, wherein said plurality of documents are stored by a search engine.

4. The media of claim 1, wherein said query log associates at least a portion of said plurality of search queries with at least a portion of said plurality of documents.

5. The media of claim 1, wherein said selecting includes determining the number of said plurality of documents that are relevant to at least one of said potential query refinements.

6. The media of claim 5, wherein said selecting includes attempting to maximize the number of said plurality of documents that are relevant to at least one of said potential query refinements.

7. The media of claim 1, wherein said method further comprises receiving a user input selecting one of said potential query refinements.

8. The media of claim 7, wherein said method further comprises using the potential query refinement selected by said user input as said search input and repeating said identifying, said utilizing and said selecting.

9. A system for presenting potential refinements to a user's search query, the system comprising:
a search component for selecting a plurality of documents in response to a search query;
a query log configured to store associations between one or more search queries and one or more of said plurality of documents;
a result-partitioning component configured to use said associations in said query log to divide at least a portion of said plurality of documents into one or more subsets, wherein each of said one or more subsets is associated with at least one search query selected from said one or more search queries and includes one or more documents from said plurality documents that are associated with said at least one search query; and
a presentation component configured to present search queries associated with at least a portion of said one or more subsets.

10. The system of claim 9, wherein said query log associates previously entered search queries with at least a portion of said plurality of documents.

11. The system of claim 9, wherein said result-partitioning component is configured to utilize a greedy algorithm to divide at least a portion of said plurality of documents into the one or more subsets.

12. The system of claim 9, wherein said result-partitioning component is configured to attempt to maximize the number of said plurality of documents placed in said one or more subsets.

13. The system of claim 9, wherein said result-partitioning component is configured to perform sampling to disqualify at least a portion of said one or more search queries from association with said one or more subsets.

14. The system of claim 9, wherein said result-partitioning component is configured to attempt to minimize overlap between said one or more subsets.

15. One or more computer-readable media having computer-useable instructions embodied thereon to perform a method for identifying search queries relevant to a search input, said method comprising:
identifying a plurality of documents that are relevant to a search input received from a user;
utilizing a query log to associate one or more search queries with one or more of said plurality of documents;
dividing at least a portion of said plurality of documents into one or more subsets, wherein each of said one or more subsets is associated with at least one search query selected from said one or more search queries and includes one or more documents from said plurality documents that are associated with said at least one search query; and
presenting to the user one or more search queries associated with at least a portion of said one or more subsets.

16. The media of claim 15, wherein said search input is a user query to an Internet search engine.

17. The media of claim 15, wherein said dividing includes minimizing overlap between said one or more subsets.

18. The media of claim 15, wherein said dividing maximizes the number of said plurality of documents placed into said one or more subsets.

19. The media of claim 15, wherein said method further comprises ranking said one or more subsets.

20. The media of claim 15, wherein said query log associates previously considered search queries with at least a portion of said plurality of documents.
